(19) United States
(12) Patent Application Publication
(10) Pub. No.: US 2007/0164916 A1
(43) Pub. Date: Jul. 19, 2007

(54) Metallized glass grounding for antenna

(76) Inventors: Imtiaz Zafar, Sterling Heights, MI (US); Joseph R. Dockemeyer JR., Kokomo, IN (US); Ahmad B. Pakray, Rochester Hills, MI (US); Kenneth P. Lee, Bingham Farms, MI (US)

Correspondence Address: DELPHI TECHNOLOGIES, INC., M/C 480-410-202, PO BOX 5052, TROY, MI, 48007, US

(21) Appl. No.: 11/333,160

(22) Filed: Jan. 17, 2006

(51) Int. Cl. H01Q 1/32

(52) U.S. Cl. 343/713; 343/711

(57) ABSTRACT

A satellite antenna is mounted on one side of a window. The window is made of metallized glass or has an electrically conductive print applied to the side opposite the satellite antenna. The electrically conductive print or metallized glass serves as a ground connection for the satellite antenna.

### TECHNICAL FIELD

This disclosure relates generally to antennas. More particularly, the disclosure relates to antennas for use in transmitting and receiving circularly polarized signals.

### BACKGROUND OF THE DISCLOSURE

The vast majority of vehicles currently in use incorporate vehicle communication systems for receiving or transmitting signals. For example, vehicle audio systems provide information and entertainment to many motorists daily. These audio systems typically include an AM/FM radio receiver that receives radio frequency (RF) signals. These RF signals are then processed and rendered as audio output.

Some vehicle communication systems incorporate tuners for receiving satellite signals used in satellite-based digital audio radio (SDAR) services. SDAR services use digital signals that are broadcast from transmitters mounted on one or more satellites orbiting the Earth. Because the signals used by SDAR systems are digital, sound quality is enhanced relative to traditional analog broadcasting systems. In addition, an SDAR transmitter can provide coverage for a much larger geographic area than the terrestrial-based transmitters used by analog broadcasters. For example, it is possible to travel across a large portion of the United States without needing to change channels as different metropolitan areas are entered and exited.

Because SDAR systems use satellite signals, a vehicle communication system that is capable of receiving these signals uses an antenna that require a clear line of sight to the satellite. The antenna is typically mounted on the exterior of the vehicle so that the vehicle body and glass will not block the satellite signals.

The antenna must be electrically connected to the tuner to provide the satellite signal to the tuner. This electrical connection is typically accomplished via one or more coaxial cables running from the antenna to the tuner. In many vehicles, the coaxial cable is routed through weather strip material located proximate the windshield or rear window glass and into the vehicle via the trunk or doors. Some vehicle bodies incorporate cable routing channels to facilitate routing the cable.

In some vehicles, the coaxial cable is located entirely or substantially entirely inside the vehicle and is coupled to the antenna by RF couplers. Conventional solutions involve using two RF couplers mounted on a window: one on the interior surface and one on the exterior surface. For optimum performance, the RF couplers must be aligned. Even when the RF couplers are aligned, the coupler loss through the window is typically approximately 1-2 dB.

### SUMMARY OF VARIOUS EMBODIMENTS

According to various example embodiments, a satellite antenna is mounted on one side of a window. The window is made of metallized glass or has an electrically conductive print applied to the side opposite the satellite antenna. The electrically conductive print or metallized glass serves as a ground connection for the satellite antenna.

One embodiment is directed to an antenna system that includes a satellite antenna mounted proximate one surface of a window panel. An electrical conductor is operatively coupled to the satellite antenna. An electrically conductive print is disposed proximate an opposite surface of the window panel. The electrically conductive print is operatively coupled to the satellite antenna to provide a ground connection for the satellite antenna.

In another embodiment, a communication system includes a receiver and a satellite antenna mounted proximate one surface of a window panel. An electrical conductor is operatively coupled to the satellite antenna. An electrically conductive print is disposed proximate an opposite surface of the window panel. The electrically conductive print is operatively coupled to the satellite antenna to provide a ground connection for the satellite antenna.

Yet another embodiment is directed to a method for installing an antenna system. An electrically conductive print is applied proximate an interior surface of a window panel. A satellite antenna is mounted proximate an exterior surface of the window panel. The electrically conductive print is coupled to the satellite antenna to provide a ground connection for the satellite antenna. An electrical conductor is coupled to the satellite antenna and to a receiver.

Various embodiments may provide certain advantages. For instance, the radio frequency (RF) couplers that are employed in certain conventional systems may be eliminated. Performance may be improved as a result. In addition, manufacturing costs can be reduced in this way.

Additional objects, advantages, and features will become apparent from the following description and the claims that follow, considered in conjunction with the accompanying drawings.

### BRIEF DESCRIPTION OF THE DRAWINGS

FIG. 1 is a conceptual diagram illustrating an example communication system according to one embodiment.

FIG. 2 is a plan view illustrating an example antenna system forming part of the communication system illustrated in FIG. 1.

FIG. 3 is a flow diagram illustrating an example method for installing the antenna system illustrated in FIG. 2.

### DESCRIPTION OF VARIOUS EMBODIMENTS

According to various embodiments, a satellite antenna is mounted on one side of a window. The window is made of metallized glass or has an electrically conductive print applied to the side opposite the satellite antenna. The electrically conductive print or metallized glass serves as a ground connection for the satellite antenna.

Various embodiments may provide certain advantages. For instance, the radio frequency (RF) couplers that are employed in certain conventional systems may be eliminated. Performance may be improved as a result. In addition, manufacturing costs can be reduced in this way.

In the following description, numerous specific details are set forth in order to provide a thorough understanding of various embodiments of the present invention. It will be apparent to one skilled in the art that various embodiments may be practiced without some or all of these specific details. In other instances, well known components have not been described in detail in order to avoid unnecessarily obscuring the invention.

For purposes of this description, terms such as “upper,” “lower,” “right,” “left,” “rear,” “front,” “vertical,” “horizontal,” and the like relate to the embodiment as illustrated and oriented in the Figures. It is to be understood that various embodiments may assume alternative orientations, except where expressly specified to the contrary. It is also to be understood that specific devices and processes are described in this disclosure by way of illustration only, and are not intended to be limiting. For example, specific dimensions and other physical characteristics relating to the embodiments described in this disclosure are not to be considered as limiting, unless the claims expressly state otherwise.

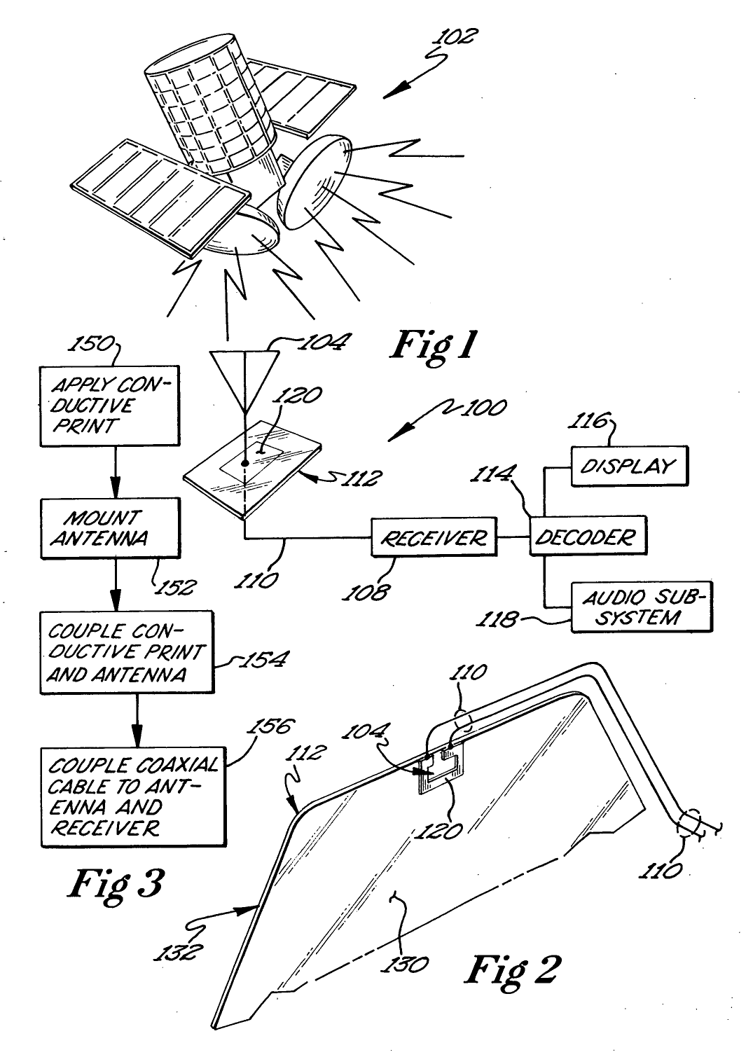

Referring now to the drawings, FIG. 1 illustrates an example communication system 100, such as a vehicle entertainment system. In the communication system 100, a radio frequency (RF) signal is transmitted, for example, from a satellite transmitter 102 to an antenna 104. A low noise amplifier (LNA), which may be integral with the antenna 104, amplifies and filters noise from the RF signal. The RF signal is conducted to an input of a receiver 108, for example, via an RF or coaxial cable 110.

The RF signal may be conducted from the exterior of the vehicle to the interior of the vehicle across a window panel 112, for example, via a hole or notch in the window panel 112. As an alternative, the RF signal may be conducted across a glass or other dielectric surface via a coupling device (not shown) that may employ capacitive coupling, slot coupling, or aperture coupling.

In the embodiment illustrated in FIG. 1, the antenna 104 is operatively coupled to the receiver 108. It will be appreciated by those skilled in the art that the antenna 104 can be operatively coupled to multiple communication devices. Some such communication devices may have both transmitting and receiving capabilities, and may be connected to antennas, such as transmitting antennas, other than the antenna 104. If the antenna 104 is located in a vehicle having multiple communication devices, the communication devices may be operatively coupled to the antenna via a high-speed data bus (not shown). The communication devices may include, e.g., one or more receivers in combination with one or more transmitters.

The receiver 108 is operatively coupled to a decoder 114, which decodes that RF signals received by the receiver 108. In addition, the decoder 114 may also perform an authentication function to verify that the communication system 100 is authorized to receive programming embodied in the RF signal. The decoded signal may contain audio and video components. The video component is rendered by a display 116, and the audio component is rendered by an audio subsystem 118, which may include a number of speakers.

In one embodiment, the antenna 104 is mounted on an exterior surface of the window 112. A conductive print 120 is formed on an interior surface of the window 112 and serves as a ground connection for the antenna 104. The conductive print 120 may contact a polyurethane adhesive (not shown) that secures the window 112 to the vehicle chassis. With the conductive print 120 providing the ground connection for the antenna 104, coupling losses associated with coupling the antenna 104 to the receiver 108 across the window 112 can be reduced.

FIG. 2 illustrates one example embodiment of the antenna 104 and the conductive print 120. The antenna 104 may be implemented as a linearly polarized or other type of SDAR antenna and is mounted on an exterior surface 130 of the window 112, which is secured to the vehicle chassis by an adhesive 132 formed, for example, from polyurethane. The antenna 104 is connected to the coaxial cable 110, which passes through a hole or notch formed in the window 112 to the interior of the vehicle.

The conductive print 120 is applied on an interior surface of the window 112 and contacts the adhesive 132. With the conductive print 120 in contact with the adhesive 132, the vehicle chassis provides an electrical ground for the conductive print 120. In this way, an electrical ground is provided for the antenna 104.

The conductive print 120 may be applied in any of a variety of patterns. The dimensions of the conductive print 120 may be selected as a function of the size of the base of the antenna 104 and the geometry of the glass available at the point of installation. Antenna characteristics are improved with increasing size of the ground plane. Accordingly, it is desirable that the conductive print 120 be as large as practicable. However, it is also desirable that the conductive print not extend outside the “blackout” region on the window 112. The “blackout” region is defined by a strip of black material located on the interior surface of the window 112 near the perimeter of the window 112, and is visible from both the interior and exterior surfaces of the window 112.

In some embodiments, the conductive print 120 is implemented as a component distinct from the glass forming the window 112. For example, the conductive print 120 may be implemented as a silver ceramic layer applied to the interior surface of the window 112. This layer may be substantially as thick as defroster lines (not shown) applied on the exterior surface 130 of the window 112. The silver ceramic may be silk screened on the interior surface of the glass and then baked at a high temperature to fuse the silver ceramic to the glass. Alternatively, the silver ceramic may be applied to the glass using any of a variety of conventional techniques.

In other embodiments, the glass forming the window 112 is itself metallized. During the glass manufacturing process, a conductive material may be fused in or embedded in the glass structure. The glass may be selectively metallized such that certain areas of the glass are conductive. Other areas of the glass, such as those in which the ground and RF signals need to be separated, are nonconductive, i.e., nonmetallized.

Using metallized glass to implement the window 112 may reduce coupling losses. For example, at frequencies around 2.338 GHz, coupling losses may be reduced to approximately 0.3 dB. These coupling losses are attributable to the RF contacts between the antenna 104 and the internal RF contact on the interior surface of the window 112. By comparison, coupling losses through glass are typically approximately 1-2 dB under conventional approaches.

FIG. 3 illustrates an example method for installing the antenna system of FIG. 2. The conductive print 120 is applied (150) proximate the interior surface of the window 112. If the window 112 is mounted to the vehicle chassis using an adhesive, the conductive print 120 may be located at least partially on the adhesive. In some embodiments, the conductive print 120 is silk screened on the interior surface of the window 112 and is fused to the interior surface of the window 112 through a baking process. Alternatively, the conductive print 120 may be applied to the interior surface of the window 112 using any of a variety of other conventional techniques. As another alternative, the window 112 itself may be metallized by fusing or embedding a conductive material in the structure of the glass that forms the window 112. Certain areas of the window 112 may be selectively metallized or nonmetallized, depending on whether conductivity is desirable in those areas.

The antenna 104 is mounted (152) proximate the exterior surface 130 of the window 112 either before or after the conductive print 120 is applied proximate the interior surface of the window 112. Next, the conductive print 120 is coupled (154) to the antenna 104. With the conductive print 120 in contact with the adhesive used to mount the window 112 to the vehicle chassis, an electrical ground for the conductive print 120 and, in turn, for the antenna 104, is provided by the vehicle chassis. The coaxial cable 110 is then coupled (156) to the antenna 104 and to the receiver 108 of FIG. 1. The coaxial cable 110 may be routed through a notch or hole formed in the window 112.

As demonstrated by the foregoing discussion, various embodiments may provide certain advantages. For instance, mounting the antenna on the window glass facilitates antenna installation in vehicles, such as convertible vehicles and vehicles having composite bodies that do not have large areas of metallic material that can provide a ground connection. Also, the radio frequency (RF) couplers that are employed in certain conventional systems may be eliminated. Performance may be improved as a result. In addition, manufacturing costs can be reduced in this way. Further, an AM/FM antenna can readily be integrated into the antenna package, thereby reducing AM/FM pigtail impedance fluctuations and improving AM/FM signal reception.

It will be understood by those skilled in the art that various modifications and improvements may be made without departing from the spirit and scope of the disclosed embodiments. The scope of protection afforded is to be determined solely by the claims and by the breadth of interpretation allowed by law.

What is claimed is:

1. An antenna system comprising:
a satellite antenna mounted proximate a first surface of a window panel;
an electrical conductor operatively coupled to the satellite antenna; and
an electrically conductive print disposed proximate a second surface of the window panel, the second surface opposite the first surface, the electrically conductive print operatively coupled to the satellite antenna to provide a ground connection for the satellite antenna.

2. The antenna system of claim 1, wherein the window panel is mounted on a vehicle chassis via an adhesive, and wherein the electrically conductive print is located at least partially on the adhesive.

3. The antenna system of claim 1, wherein the electrically conductive print comprises a silver ceramic applied to the second surface of the window panel.

4. The antenna system of claim 3, wherein the silver ceramic is applied to the second surface of the window panel via a silk screening process and baked to fuse the silver ceramic to the window panel.

5. The antenna system of claim 1, wherein the window panel has a glass structure and comprises an electrically conductive material incorporated in the glass structure.

6. The antenna system of claim 5, wherein the electrically conductive material is fused in the glass structure.

7. The antenna system of claim 1, wherein the window panel defines an aperture and the electrical conductor is routed through the aperture.

8. A communication system comprising:
a receiver;
a satellite antenna mounted proximate a first surface of a window panel;
an electrical conductor operatively coupled to the satellite antenna and to the receiver; and
an electrically conductive print disposed proximate a second surface of the window panel, the second surface opposite the first surface, the electrically conductive print operatively coupled to the satellite antenna to provide a ground connection for the satellite antenna.

9. The communication system of claim 8, wherein the window panel is mounted on a vehicle chassis via an adhesive, and wherein the electrically conductive print is located at least partially on the adhesive.

10. The communication system of claim 8, wherein the electrically conductive print comprises a silver ceramic applied to the second surface of the window panel.

11. The communication system of claim 10, wherein the silver ceramic is applied to the second surface of the window panel via a silk screening process and baked to fuse the silver ceramic to the window panel.

12. The communication system of claim 8, wherein the window panel has a glass structure and comprises an electrically conductive material incorporated in the glass structure.

13. The communication system of claim 12, wherein the electrically conductive material is fused in the glass structure.

14. The communication system of claim 8, wherein the window panel defines an aperture and the electrical conductor is routed through the aperture.

15. A method for installing an antenna system, the method comprising:
applying an electrically conductive print proximate an interior surface of a window panel;
mounting a satellite antenna proximate an exterior surface of the window panel;
coupling the electrically conductive print to the satellite antenna to provide a ground connection for the satellite antenna; and
coupling an electrical conductor to the satellite antenna and to a receiver.

16. The method of claim 15, wherein the window panel is mounted on a vehicle chassis via an adhesive, and wherein the electrically conductive print is located at least partially on the adhesive.

17. The method of claim 15, wherein the electrically conductive print comprises a silver ceramic applied to the interior surface of the window panel.

18. The method of claim 17, wherein the silver ceramic is applied to the interior surface of the window panel via a silk screening process and baked to fuse the silver ceramic to the window panel.

19. The method of claim 15, wherein the window panel has a glass structure and comprises an electrically conductive material incorporated in the glass structure.

20. The method of claim 19, wherein the electrically conductive material is fused in the glass structure.

21. The method of claim 15, wherein the window panel defines an aperture and the electrical conductor is routed through the aperture.
